(19) United States
(12) Patent Application Publication
(10) Pub. No.: US 2013/0333452 A1
(43) Pub. Date: Dec. 19, 2013

(54) LIQUID CHROMATOGRAPH, SAMPLE INTRODUCTION DEVICE FOR LIQUID CHROMATOGRAPH, AND METHOD FOR CLEANING SAMPLE INTRODUCTION DEVICE FOR LIQUID CHROMATOGRAPH

(71) Applicants: Hiroshi Suzuki, Hitachinaka (JP); Kimihiko Ishii, Hitachinaka (JP); Mitsuhiko Ueda, Hitachinaka (JP); Katsutoshi Shimizu, Hitachinaka (JP); Yoshiaki Seki, Hitachinaka (JP)

(72) Inventors: Hiroshi Suzuki, Hitachinaka (JP); Kimihiko Ishii, Hitachinaka (JP); Mitsuhiko Ueda, Hitachinaka (JP); Katsutoshi Shimizu, Hitachinaka (JP); Yoshiaki Seki, Hitachinaka (JP)

(21) Appl. No.: 13/989,713

(22) PCT Filed: Nov. 17, 2011
(86) PCT No.: PCT/JP11/76523

§ 371 Date: Aug. 14, 2013

(30) Foreign Application Priority Data
Dec. 2, 2010 (JP) 2010-268920

(51) Int. Cl. G01N 1/02

(52) U.S. Cl. CPC G01N 1/02
USPC 73/64.56

(57) ABSTRACT

Disclosed is a liquid chromatograph provided with: a first flow path switching means which switches between connection of a sample storage loop to a mobile phase flow path and separation of the sample storage loop from the mobile phase flow path; a needle which suctions and discharges a sample; a weighing means which performs suction and discharge of the sample to the needle while weighing the sample; a cleaning solution feeding means which feeds a cleaning solution; a second flow path switching means which switches between at least two types of cleaning solutions; a third flow path switching means which switches between connection of the needle and the weighing means and connection of the needle and the cleaning solution feeding means; and a control means which controls operation of the first flow path switching means, the weighing means, the cleaning solution feeding means, the second flow path switching means, and the third flow path switching means, wherein the total amount of the sample is injected into the sample storage loop and the cleaning solution is injected into a flow path from the sample storage loop to a sample inlet.

### TECHNICAL FIELD

The present invention relates to a liquid chromatograph, a sample introduction device for a liquid chromatograph, and a method for cleaning a sample introduction device for a liquid chromatograph.

### BACKGROUND ART

In a liquid chromatograph, which is a type of liquid sample analyzer, a mobile phase (eluting solvent) is sucked by a pump, and the mobile phase is transferred to a column together with a sample introduced by an automatic sample introduction device. The sample introduced into the column is separated into respective components, which are detected by various detectors. In general, in a field of apparatuses referred to as high performance liquid chromatographs (HPLC), analysis is required to be performed at high pressure of 20 MPa to 40 MPa at the maximum. A pump for such a HPLC is required to be capable of supplying a mobile phase correctly and precisely even at high pressure.

An automatic sample introduction device is an device for sucking a sample liquid using a needle from sample retaining containers arranged in a sample rack, subsequently storing the sample in a sample storage loop, and automatically injecting the sample into a mobile phase flow path of a liquid chromatograph. Many automatic sample introduction devices are used that have pretreatment functions of diluting a sample before injecting the sample into a mobile phase flow path and of mixing the sample with a reagent to make a label, or the like.

Injection schemes in such automatic sample introduction devices are classified into two types: a direct injection scheme (e.g., see Patent Literatures 1 and 2) integrating a needle and a sample storage loop into a part of a mobile phase flow path at high pressure, and a loop injection scheme (e.g., see Patent Literatures 3 and 4) integrating only a sample storage loop into a part of a mobile phase flow path at high pressure.

According to the direct injection scheme, a sample temporarily stored in the needle and the sample storage loop is flushed into a column by a mobile phase at the start of analysis, and the contents of the needle and the sample storage loop are continuously flushed by the mobile phase during analysis. Accordingly, this scheme is advantageous in that the sucked sample can be introduced into the column without waste, which negates the need of another means for cleaning the inside of the needle contaminated with the sample.

However, because of the principle that integrates the needle into a part of the mobile phase flow path during analysis, a structure for retaining liquid tightness between the needle and a sample inlet of a sample retaining container at high pressure is required, which is disadvantageous in being unsuitable for sample handling, such as dilution and mixing in pretreatment.

On the contrary, according to the loop injection scheme, the needle is out of the mobile phase flow path at high pressure during analysis. Accordingly, even in analysis, needle can be moved and sample can be measured, which negates the need of a structure of retaining liquid tightness between the needle and the sample inlet of the sample retaining container. Thus, pretreatment on the sample can advantageously be performed in analysis. However, another means for cleaning the inside of the needle and a process therefor are required instead, which is disadvantageous in that the time required for sample injection is longer than that in the direct injection scheme.

Thus, the above two types of injection schemes have advantages and disadvantages with respect to each other. Accordingly, it is preferable that any of the schemes be selectable in conformity with purposes and applications of analysis.

### PRIOR ART DOCUMENTS

### Patent Literature

Patent Literature 1: JP-A-1-248055
Patent Literature 2: JP-A-2006-292641
Patent Literature 3: JP-A-6-235722
Patent Literature 4: JP-A-61-114143

### SUMMARY OF INVENTION

### Problem to be Solved by the Invention

In the sample introduction unit of the above mentioned loop injection type, in case of that it is desired that the whole amount of the sample is introduced in the column laconically, in a process of temporarily storing in the sample storage loop the sample to be introduced into the column, both of the washing solution and the actual sample solution are stored simultaneously in the sample storage loop. That is, the washing solution is introduced into the column finally, whereby there are the following problems in the prior art.

At first, in a case of that the mobile phase and the washing solution are different in their solvents, the washing solution itseft reaches a detector without being strongly held in the column, or substantially passing straight therethrough. Here, in a case of that the mobile phase and the washing solution are different in wave-length characteristic with respect to optical absorption, a difference in the optical absorption is detected by the detector, and recorded in a chromatogram. This ghost peak by the washing solution causes a problem especially when a fine amount of the sample is analyzed in high sensitibity.

At second, even in a case of that the mobile phase and the washing solution are equal in their solvents, especially when a solubility of a component of the sample into the washing solution is high, an attenuation of the sample solution is accelerated in the above mentioned sample introduction process, so that the sample solution is stored in the sample storage loop with an enlarged band-width. As a result of this, the sample solution with the enlarged band-width reaches the column, whereby a peak width of the chromatogram of the component of the sample detected by the detector is enlarged. That is, there is a problem of that a separation performance of a target component is deteriorated to increase an analysis time period, and a processing performance as the chromatograph device is decreased. Further, additionally, there is a problem of that a peak height of the chromatogram of the component of the sample is reduced, whereby a sensitivity of the liquid chromatogram is decreased.

An object of the invention is to provide a liquid chromatograph, a sample introduction device for the liquid chromatograph and a cleaning method of the sample introduction device for the liquid chromatograph, wherein a ghost peak is prevented from being detected, and a separation performance of the chromatogram is improved, so that a time period of analysis with high sensitivity is prevented from being entended.

### Means for Solving the Problem

For achieving the above object, the invention comprises a first flow passage switching means including a sample storage loop to switch the sample storage loop between a connection thereof to a flow passage of a mobile phase and a disconnection thereof from the flow passage of the mobile phase, a needle for sucking and discharging a sample, a metering means performing sucking of the sample into the needle and discharging the sample while metrizing the sample, a washing solution feeding means transferring a washing solution, a second flow passage switching means switching at least two kinds of the washing solution, a third flow passage switching means performing switching between a connection between the needle and the metering means and a connection between the needle and the washing solution feeding means, and a control means controlling operations of the first flow passage switching means, the metering means, the washing solution feeding means, the second flow passage switching means and the third flow passage switching means.

Further, in the invention, the whole of the sample is injected into the sample storage loop while the washing solution is injected into a flow passage extending from the sample storage loop to a sample injection port.

### Advantageous Effects of Invention

The present invention prevents a ghost peak from being detected, and improves the degree of separation of a chromatogram, thereby providing a liquid chromatograph, a sample introduction device for a liquid chromatograph, and a method for cleaning a sample introduction device for a liquid chromatograph that have a high sensitivity and can prevent analysis time from becoming long.

Other objects characteristics and advantages of the present invention will be apparent from description of embodiments of the present invention pertaining to accompanying drawings.

### BRIEF DESCRIPTION OF DRAWINGS

FIG. 1 is a schematic diagram of a configuration of a liquid chromatography apparatus including a loop injection automatic sample introduction device, which is an embodiment of the present invention.

FIG. 2 is a functional diagram showing a control target of an operation controller.

FIG. 3 is a schematic diagram of a configuration of a liquid chromatography apparatus as with FIG. 1.

FIG. 4 is a schematic diagram of a configuration of a liquid chromatography apparatus as with FIG. 1.

FIG. 5 is a schematic diagram of a configuration of a liquid chromatography apparatus as with FIG. 1.

FIG. 6 is a schematic diagram of a configuration of a liquid chromatography apparatus as with FIG. 1.

FIG. 7 is a schematic diagram of a configuration of a liquid chromatography apparatus as with FIG. 1.

FIG. 8 is a schematic diagram of a configuration of a liquid chromatography apparatus as with FIG. 1.

FIG. 9 is a schematic diagram of a configuration of a liquid chromatography apparatus as with FIG. 1.

FIG. 10 is a schematic diagram of a configuration of a liquid chromatography apparatus as with FIG. 1.

FIG. 11 is a schematic diagram of a configuration of a liquid chromatography apparatus as with FIG. 1.

FIG. 12 is a schematic diagram of a configuration of a liquid chromatography apparatus as with FIG. 1.

FIG. 13A is a graph showing an example of a chromatogram.

FIG. 13B is a graph showing an example of a chromatogram.

FIG. 14A is a graph showing an example of a chromatogram.

FIG. 14B is a graph showing an example of a chromatogram.

### DESCRIPTION OF EMBODIMENTS

Embodiments of the present invention will be described below with reference to accompanying drawings.

### Embodiments

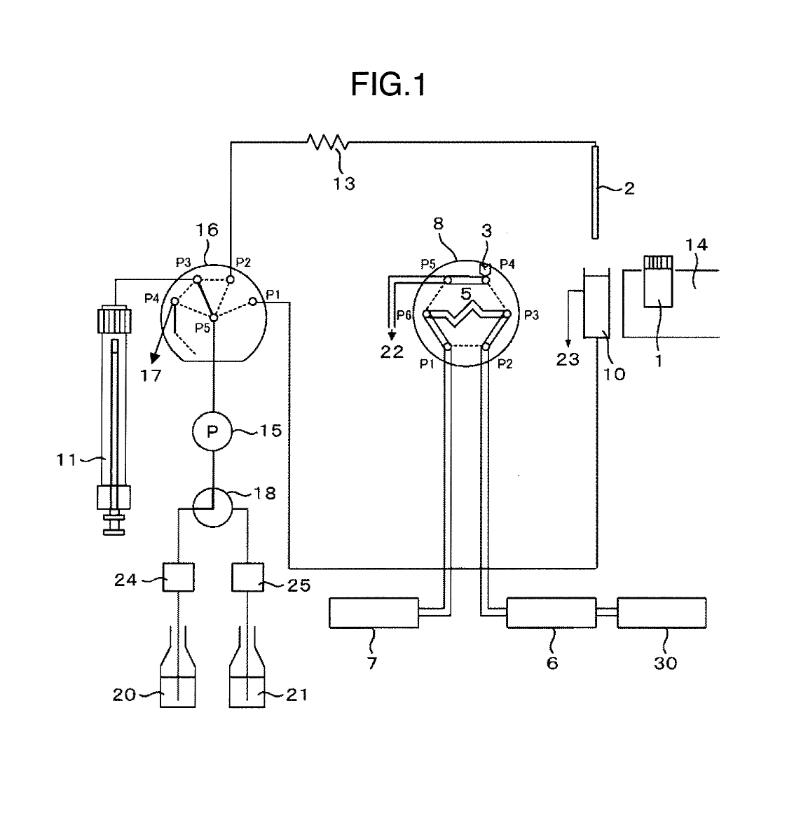

FIG. 1 is a schematic diagram of a configuration of a liquid chromatography apparatus including a loop injection automatic sample introduction device, which is an embodiment of the present invention. A sample retaining container 1 is arranged on a sample rack 14. A needle 2 is moved among the sample retaining container 1, a cleaning tank 10, a sample inlet 3 of a 6-port 2-position injection valve 8 by a needle moving mechanism, not shown.

The 6-port 2-position injection valve 8 includes six ports, and a flow path allowing two adjoining ports thereamong to communicate with each other. In an injection position, the port P1 communicates with the port P6, the port P2 communicates with the port P3, and the port P4 communicates with the port P5, as shown in the drawing. Furthermore, the port P1 is connected with a pump 7. The port P2 is connected with a column 6. The port P3 and the port P6 are connected with each other through a sample storage loop 5. The port P4 is connected with the sample inlet 3. The port P5 is connected with a drain 22 for discharging waste fluid. Moreover, the column 6 is connected to a detector 30 via a tube. The detector 30 detects a separated sample supplied from the column 6, and transmits a detection signal to a data processor, not shown.

The 6-port 2-position injection valve 8 can take another position by being turned by 60 degrees. As shown by broken lines in FIG. 1, in a load position, the port P1 communicates with the port P2, the port P3 communicates with the port P4, and the port P5 communicates with the port P6.

In the load position, the pump 7, the port P1, the port P2 and the column 6 communicate with each other in this order. The sample is not injected into a mobile phase transferred from the pump 7, and the mobile phase flows to the column. The needle 2, the sample inlet 3, the port P4, the port P3, the sample storage loop 5, the port P6, the port P5 and the drain 22 communicate with each other in this order. The sample sucked from the sample retaining container 1 by the needle 2 is injected through the sample inlet 3, and the sample storage loop 5 is filled with the sample.

In the injection position, the sample retained in the sample storage loop 5 is flushed to the column 6 by the mobile phase transferred from the pump 7. In the case where the sample is changed, the needle 2 is positioned at the cleaning tank 10 to clean the needle 2, and a cleaning solution is caused to flow from the cleaning pump 15 to the needle 2 via a syringe valve 16. The needle 2 is positioned at the sample inlet 3, thereby cleaning the injection valve 8.

The cleaning pump 15, the syringe valve 16, a plunger cleaning flow path 17, a three-way valve 18, a cleaning solution container 20, a cleaning solution container 21, a deaerator 24 and a deaerator 25 are collectively referred to as a cleaning unit.

The 5-port 4-position syringe valve 16 has five ports, and is provided with passages including four positions indicated by solid lines and broken lines in the diagram. The passage allows two of the ports to communicate with each other. The port P1 communicates with the cleaning tank 10. The port P2 communicates with the needle 2. The port P3 communicates with a syringe 11 for measuring the sample. The port P4 communicates with the plunger cleaning flow path 17 for cleaning the plunger of the pump 7. The port P5 communicates with the cleaning pump 15. The four positions can be taken by turning by 45 degrees. In the first position, the port P5 communicates with the port P1, and the port P2 communicates with the port P3. In the second position, the port P5 communicates with the port P2 and the port P3 communicates with the port P4. The third position, which is indicated by the solid line in the diagram, only allows the port P5 to communicate with the port P3. The fourth position only allows the port P5 to communicate with the port P4.

Two types of cleaning solutions are prepared according to the usage. The cleaning solution A is retained in the cleaning solution container 20. The cleaning solution B is retained in the cleaning solution container 21. Any one of the cleaning solutions A and B according to the three-way valve 18 is sucked by the cleaning pump 15 via deaerators 24 and 25, and transferred through the syringe valve 16 and a buffer tube 13 to the needle 2. Communication between the plunger cleaning flow path 17 and the pump 7 allows salts that are included in the mobile phase and deposited on the surface of the plunger of the pump 7 to be cleaned.

During the syringe valve 16 being in the position where the port P1 communicates with the port P5 and the port P2 communicates with the port P3, the needle 2 is connected with the syringe 11 for measuring the sample, via the buffer tube 13. The liquid in the tube between the needle 2 and the syringe 11 is sucked and discharged by operating the syringe 11 upward and downward.

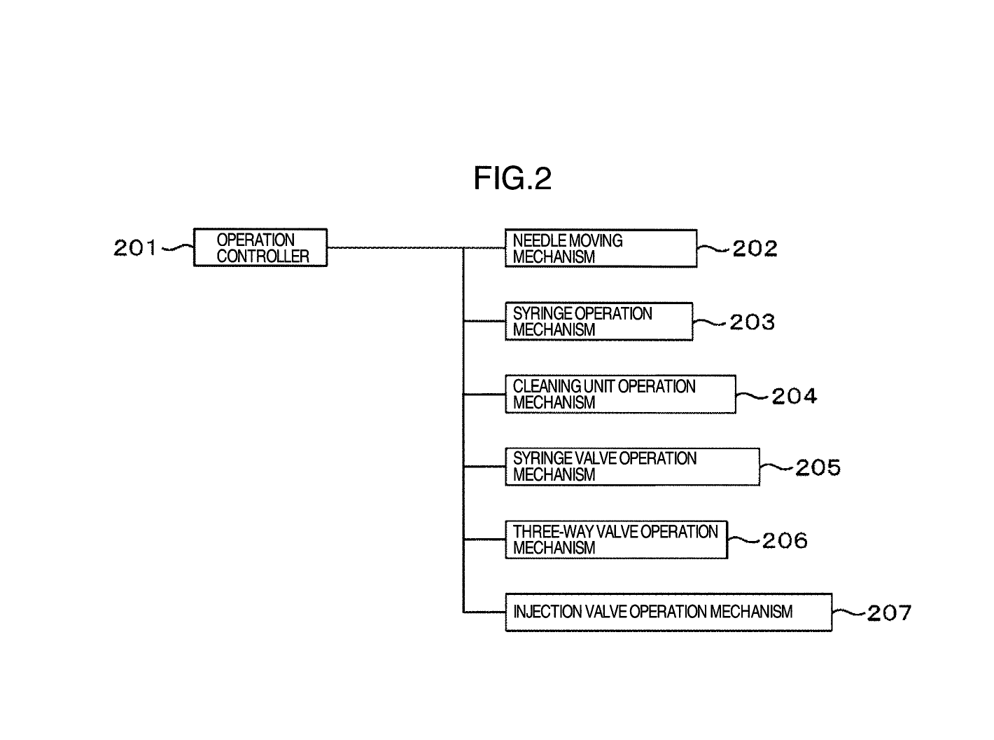

FIG. 2 is a functional diagram showing control targets of an operation controller 201 that controls movable mechanisms, such as valves of the liquid chromatography apparatus.

The operation controller 201 includes a processor executing a control program preliminarily held in a memory, not shown, and transmits operation instructions to a needle moving mechanism 202, a syringe operation mechanism 203, a cleaning unit operation mechanism 204, a syringe valve operation mechanism 205, a three-way valve operation mechanism 206, and an injection valve operation mechanism 207.

The movement, sucking and discharging operations of the syringe 11 are controlled by the syringe operation mechanism 203. The cleaning unit is operated by the cleaning unit operation mechanism 204. The syringe valve 16 is operated by the syringe valve operation mechanism 205. The three-way valve 18 is operated by the three-way valve operation mechanism 206. The injection valve 8 is operated by the injection valve operation mechanism 207.

Next, a sample injection process will be described. The loop injection scheme in this embodiment transfers the total amount of the sample sucked from the needle 2 to the sample storage loop 5 of the injection valve 8, and causes the sample to reach the column 6 for separating the sample. Accordingly, this scheme is also referred to as the total amount injection scheme. Here, terms are defined as follows.

vi: injection volume, which is a net volume of sample introduction to the mobile phase flow path.

vf: feed volume.

vd: dead volume, which ranges from the sample inlet to the injection valve.

va: air volume, which is a volume of an air layer before and after the sample.

Here, the setting of whether the sample is sandwiched before and after va or not can be selected by the automatic sample introduction device.

The aforementioned FIG. 1 shows the flow path where the automatic sample introduction device is initialized and in an idle state. The mobile phase into which no sample has been injected flows from the pump 7 to the column 6 via the sample storage loop 5 of the injection valve 8. Meanwhile, the cleaning solution container 20 for retaining the cleaning solution A is connected with the syringe 11 via the port P3, which communicates with the three-way valve 18, the cleaning pump 15 and the port P5 of the syringe valve 16, thereby cleaning the inside of the syringe 11 with the cleaning solution A. The needle 2 is positioned above the cleaning tank 10, and liquid dropping from the needle 2 is received by the cleaning tank 10.

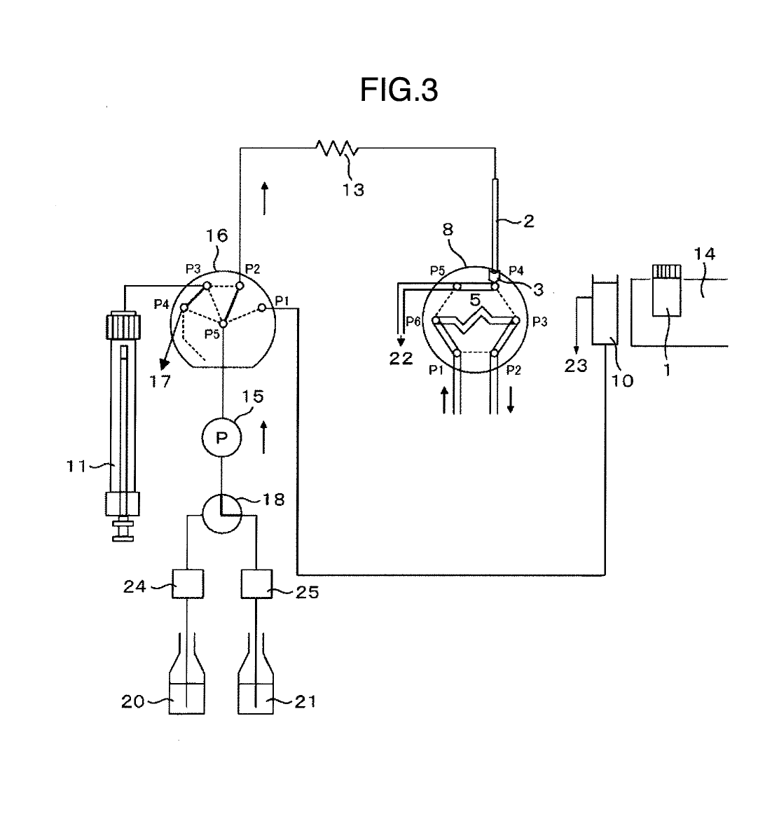

FIG. 3 is a schematic diagram of a configuration of a liquid chromatography apparatus, as with FIG. 1, and shows a state where the contents of the buffer tube 13 and the needle 2 are replaced with the cleaning solution B retained in the cleaning solution container 21, thereby cleaning the tube and the needle. The needle 2 is moved to the sample inlet 3 to communicate with the port P4 of the injection valve 8. The syringe valve 16 is turned clockwise by 45 degrees from the state of FIG. 1. The turn switches the position to that where the port P5 communicates with the port P2 and the port P3 communicates with the port P4. Furthermore, the three-way valve 18 is switched to the cleaning solution container 21 retaining the cleaning solution B. The cleaning pump 15 transfers the cleaning solution B to the syringe valve 16, the buffer tube 13, the needle 2 and the injection valve 8, thereby cleaning the inside of the port P5 communicating with the port P4 of the injection valve 8. The cleaning solution B is then discharged from the drain 22.

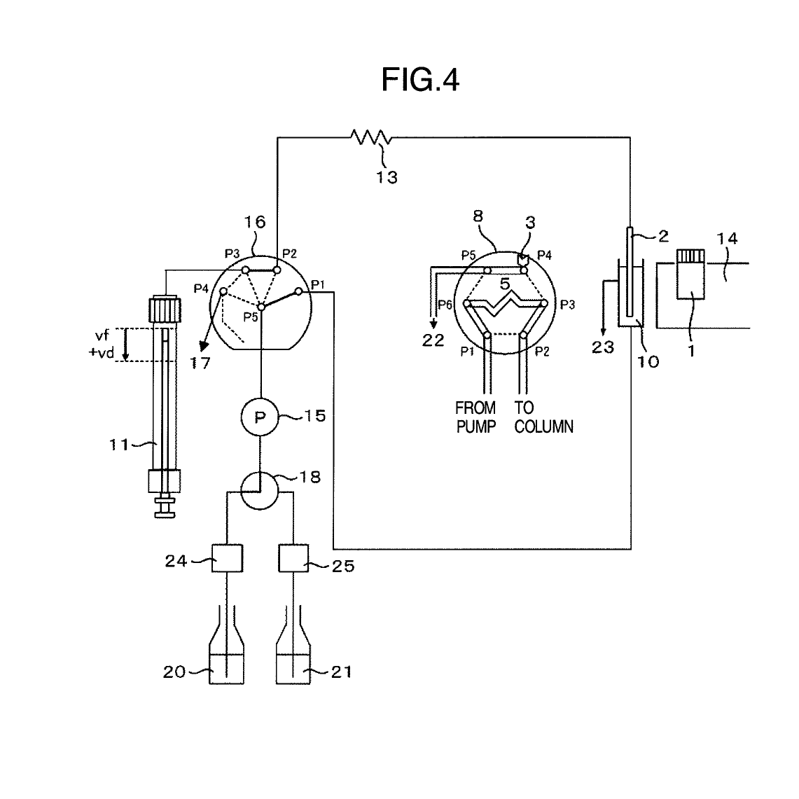

FIG. 4 is a schematic diagram of a configuration of a liquid chromatography apparatus, as with FIG. 1, and shows a state where the outside of the needle 2 is cleaned with the cleaning solution A in the cleaning tank 10. The positions of the ports of the injection valve 8 are not changed, and the syringe valve 16 is turned clockwise by 45 degrees from the state in FIG. 3, thereby switching the position to that where the port P5 communicates with the port P1 and the port P2 communicates with the port P3. The cleaning pump 15 transfers the cleaning solution A in the cleaning solution container 20 to the cleaning tank 10 via the syringe valve 16, thereby soaking the needle 2 in the cleaning solution A in the cleaning tank 10. The cleaning solution A is sucked by the syringe 11, thereby filling the tube including the syringe valve 16 and the needle 2 with this solution. The amount of suction is vf+vd, i.e., the sum of the feed volume and the dead volume. The needle 2 is soaked in the cleaning tank 10, thereby cleaning the outside of the needle 2.

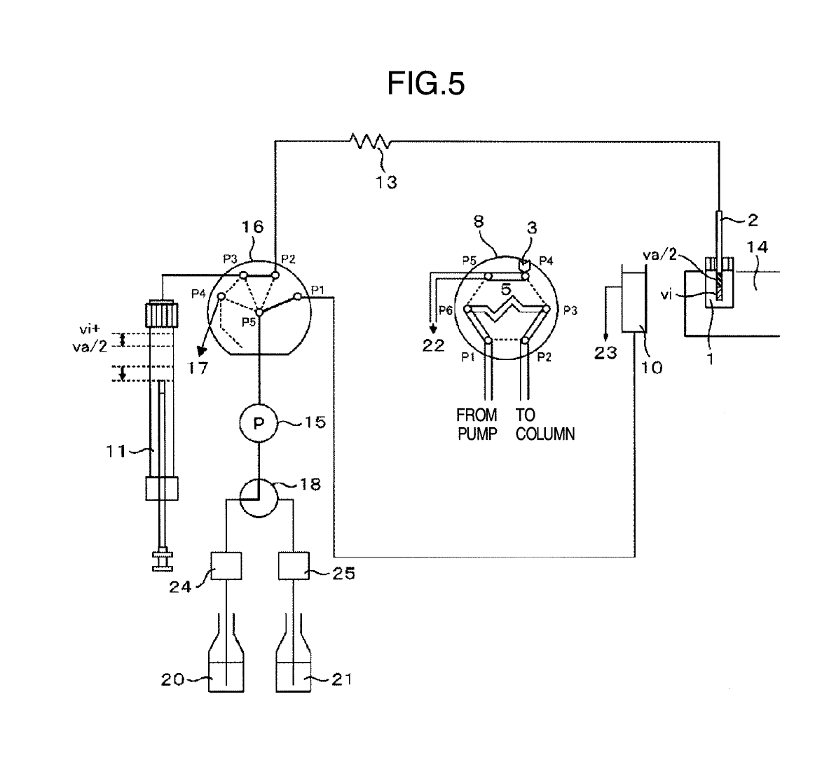

FIG. 5 is a schematic diagram of a configuration of a liquid chromatography apparatus, as with FIG. 1, and shows a process of sucking the sample. As shown in FIG. 5, the positions of the ports of the syringe valve 16 and the injection valve 8 are not changed, and the needle 2 is moved from the cleaning tank 10 to the sample retaining container 1. In the process of the movement, air is sucked by the syringe 11. The amount of suction is half an air volume va. Next, the needle 2 is moved to the sample retaining container 1, and the sample is sucked by the syringe 11. The amount of suction is the injection volume vi.

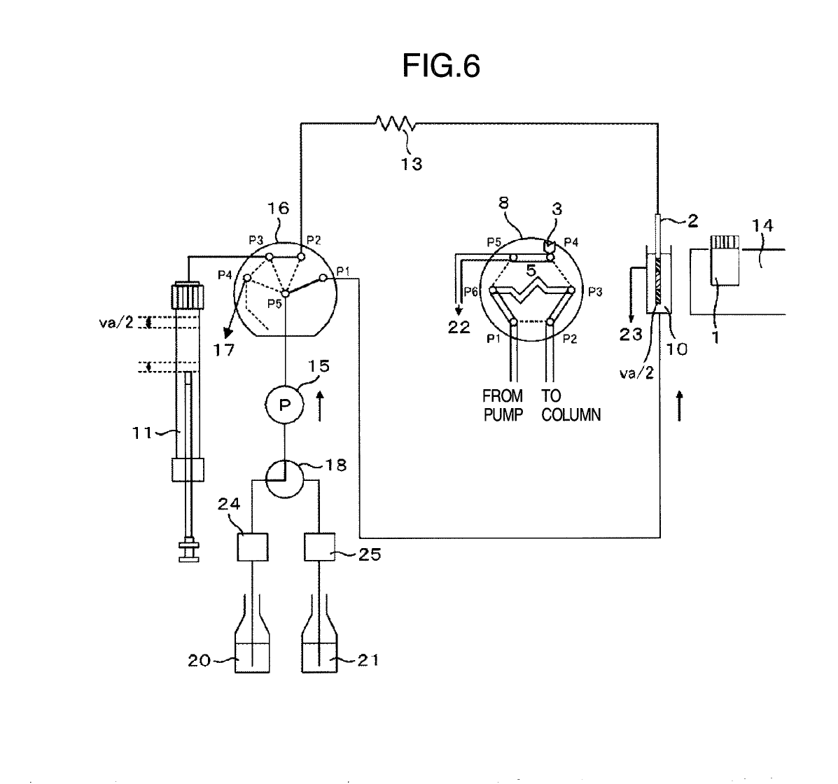

FIG. 6 is a schematic diagram of a configuration of a liquid chromatography apparatus, as with FIG. 1, and shows a state where the outside of the needle 2 is cleaned with the cleaning solution A after the sample is sucked. As shown in FIG. 6, the positions of the syringe valve 16 and the injection valve 8 are not changed, and the needle 2 is moved from the sample retaining container 1 to the cleaning tank 10. In the process of the movement, air having an amount half as large as the air volume va is sucked by the syringe 11. After the needle 2 is moved to the cleaning tank 10, the cleaning pump 15 transfers the cleaning solution A to the cleaning tank 10 to clean the outside of the needle 2. The cleaning solution A overflown from the cleaning tank 10 is discharged from the drain 23.

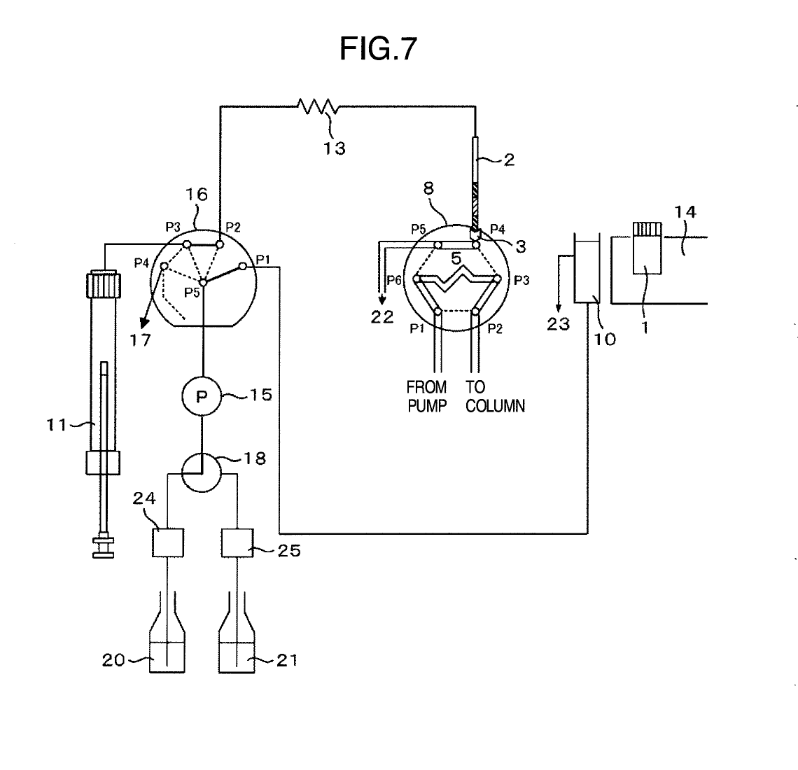

FIG. 7 is a schematic diagram of a configuration of a liquid chromatography apparatus, as with FIG. 1, and shows a state where the needle 2 is moved to the sample inlet 3 of the injection valve 8. As shown in FIG. 7, the positions of the ports of the syringe valve 16 and the injection valve 8 are not changed, and the needle 2 is moved to the sample inlet 3 of the injection valve 8, thus preparing injection of the sample from the port P4 to the injection valve 8.

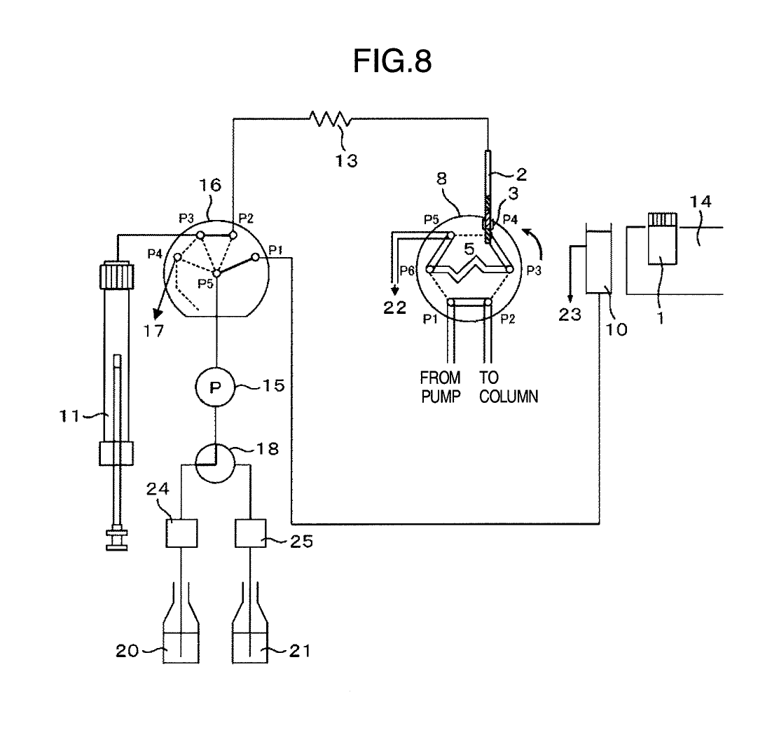

FIG. 8 is a schematic diagram of a configuration of a liquid chromatography apparatus, as with FIG. 1, and shows a state where the pressure in the sample storage loop 5 is reduced. In the states up to the state shown in FIG. 7, the sample storage loop 5 is connected with the pump 7 to allow the inside of this loop to serve as the mobile phase flow path. Accordingly, the pressure is higher than atmospheric pressure. As shown in FIG. 8, the positions of the ports of the syringe valve 16 are not changed, and the injection valve 8 is turned counterclockwise by 60 degrees. The turn separates the sample storage loop 5 of the injection valve 8 from the mobile phase flow path of the pump 7, thus separating the sample storage loop 5 at high pressure from the mobile phase flow path. This separation allows the pressure in the sample storage loop 5 to be released to atmospheric pressure through the drain 22.

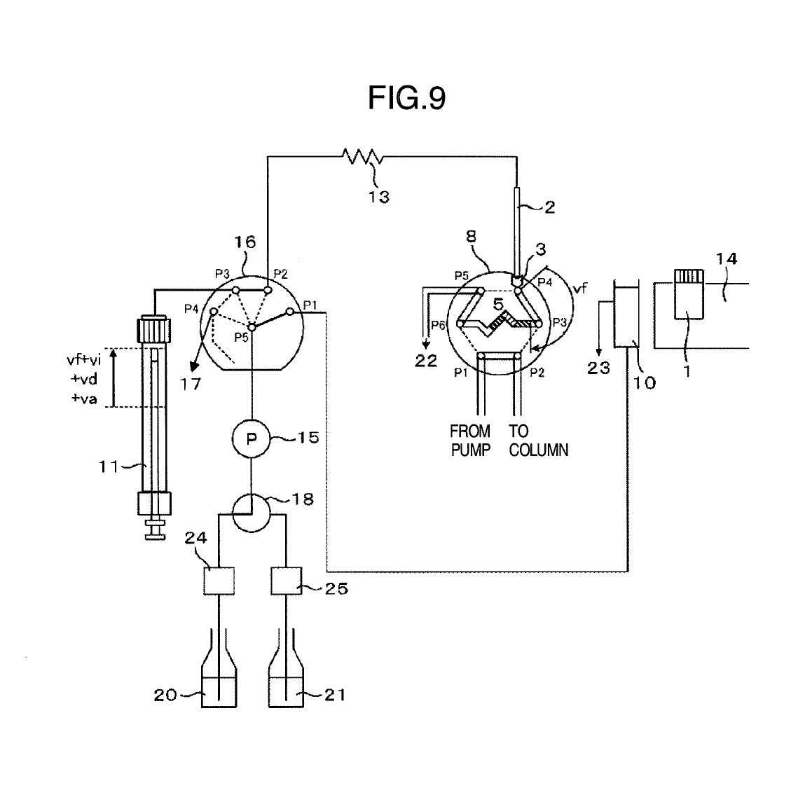

FIG. 9 is a schematic diagram of a configuration of a liquid chromatography apparatus, as with FIG. 1, and shows a process of transferring the sample sucked by the needle 2 to the injection valve 8. As shown in FIG. 9, the positions of the ports of the syringe valve 16 and the injection valve 8 are not changed, and the cleaning solution A and air in the syringe 11 are flushed, thereby transferring the sample in the needle 2 to the sample storage loop 5 in the injection valve 8 through the port P4 of the injection valve 8. The amount flushed by the syringe 11 is the sum of the feed volume, the injection volume, the dead volume and the air volume, i.e., vf+vi+vd+va. After the sample with the volume vi sucked by the process in FIG. 5 is transferred, the cleaning solution A with the volume of sucked by the process in FIG. 4 is transferred to the injection valve 8. Accordingly, the sample storage loop 5 can be filled with the total amount of the sample.

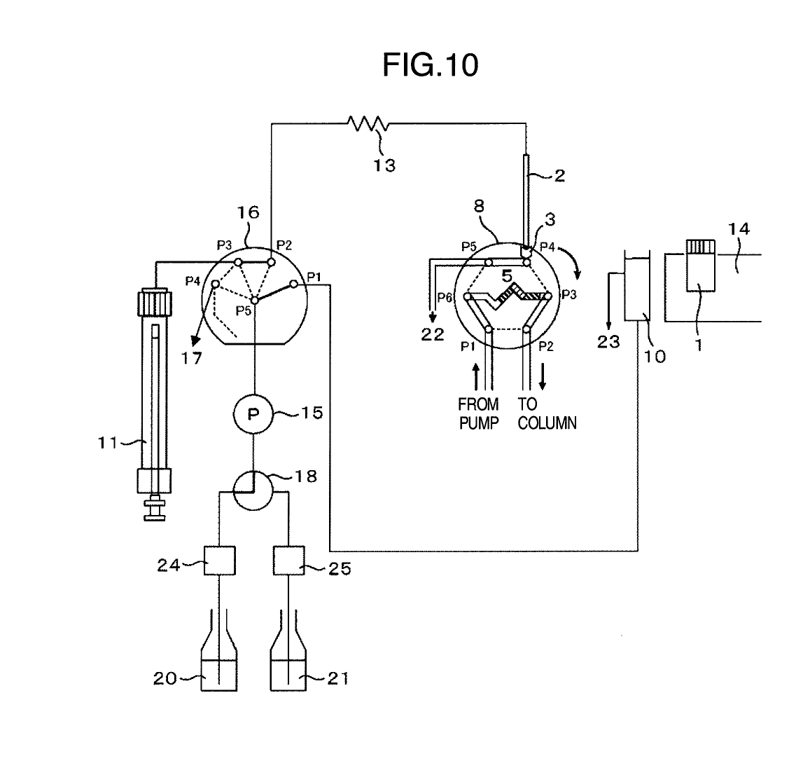

FIG. 10 is a schematic diagram of a configuration of a liquid chromatography apparatus, as with FIG. 1, and shows a process of introducing the sample retained in the sample storage loop 5 to the mobile phase flow path. As shown in FIG. 10, the positions of the ports of the syringe valve 16 are not changed, and the injection valve 8 is turned clockwise by 60 degrees, thereby causing the port P3 of the sample storage loop 5 to communicate with the port P2 connected with the column 6, causing the port P6 of the sample storage loop 5 to communicate with the port P1 connected with the pump 7. With the communication, the pump 7 causes the mobile phase to flow to the sample storage loop 5, and transfers the mobile phase to the column 6 together with the sample. Meanwhile, for preparation for the next process, the syringe 11 is moved to the top dead center. This movement discharges the liquid in which the cleaning solution A in the needle 2 and the residue of the sample are mixed, from the sample inlet 3 to the drain 22 through the ports P4 and P5 of the injection valve 8.

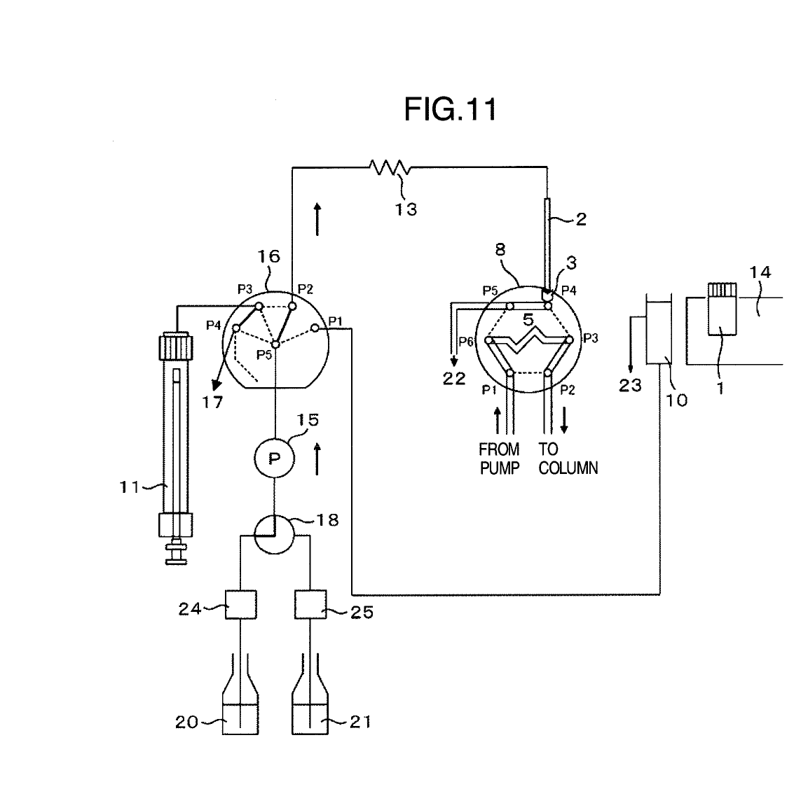

FIG. 11 is a schematic diagram of a configuration of a liquid chromatography apparatus, as with FIG. 1, and shows a process of cleaning the inside of the needle 2 with the cleaning solution A. As shown in FIG. 11, the positions of the ports of the injection valve 8 are not changed, and the syringe valve 16 is turned counterclockwise by 45 degrees, thereby switching the position to that where the port P5 communicates with the port P2 and the port P3 communicates with the port P4. The cleaning pump 15 transfers the cleaning solution A retained in the cleaning solution container 20 to the needle 2 via the syringe valve 16, and the inside of the needle 2 is cleaned with the cleaning solution A. The cleaning solution A is then discharged from the drain 22.

After cleaning of the needle 2 shown in FIG. 11 is completed, the syringe valve 16 is turned counterclockwise by 45 degrees. The turn causes the port P5 of the syringe valve 16 to communicate with the port P3, thereby causing the state to transition to the idle state shown in FIG. 1. The needle 2 is moved above the cleaning tank 10.

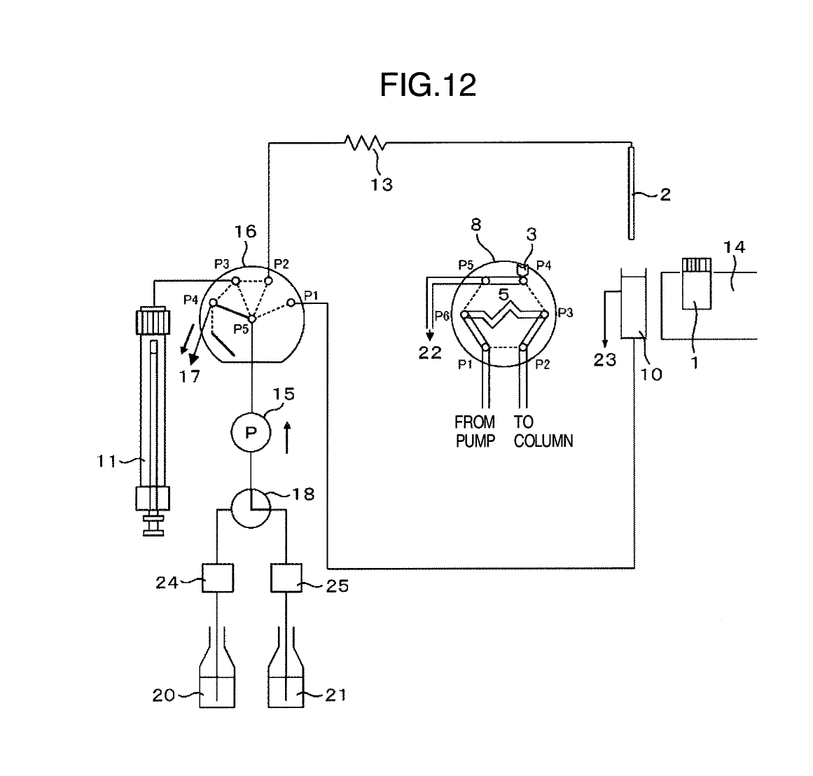

FIG. 12 is a schematic diagram of a configuration of a liquid chromatography apparatus, as with FIG. 1, and shows a process performed after cleaning of the needle 2 shown in FIG. 10 in the case where cleaning of the plunger of the pump 7 is preset. The syringe valve 16 is turned counterclockwise by 90 degrees, thereby switching the position to that where the port P5 communicates with the port P4. In the case of cleaning the plunger with the cleaning solution B instead of the cleaning solution A, the three-way valve 18 is switched to be connected to the cleaning solution container 21, and the cleaning solution B is sucked by the cleaning pump 15 and transferred from the plunger cleaning flow path 17 to the plunger of the pump 7, not shown. The cleaning time is preset. After completion, the syringe valve 16 is turned clockwise by 45 degrees, thereby causing the state to transition to the idle state shown in FIG. 1.

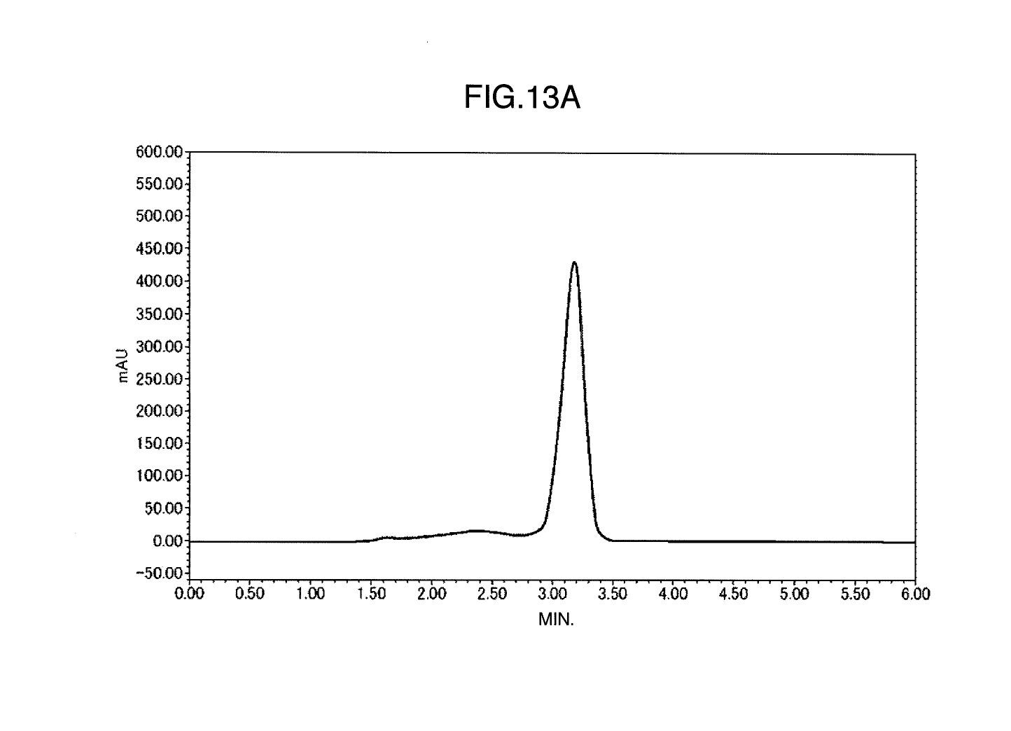

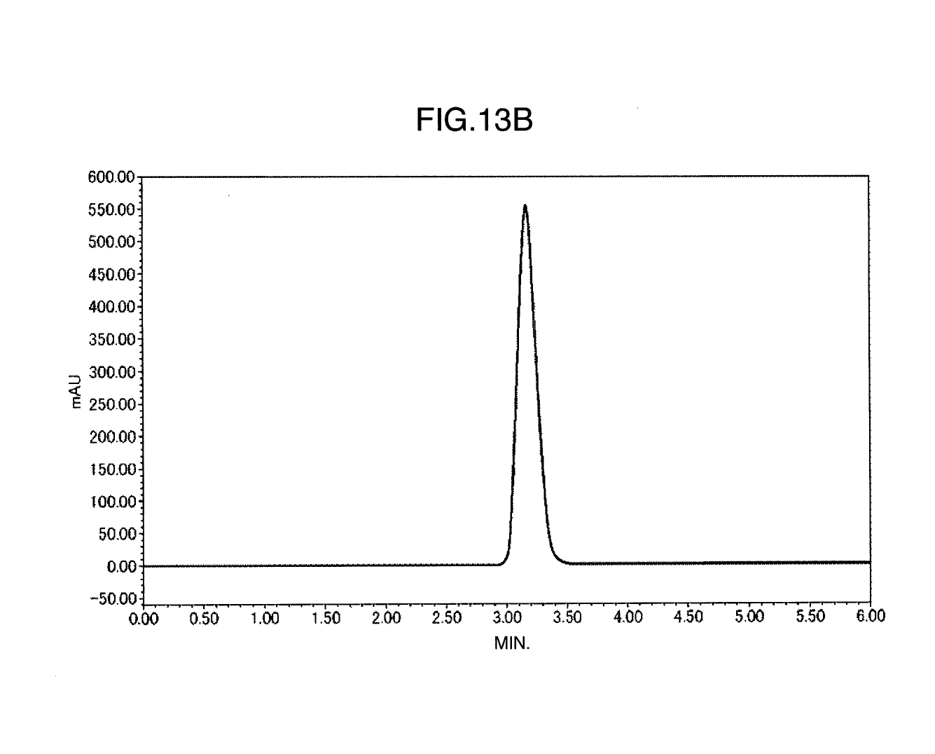

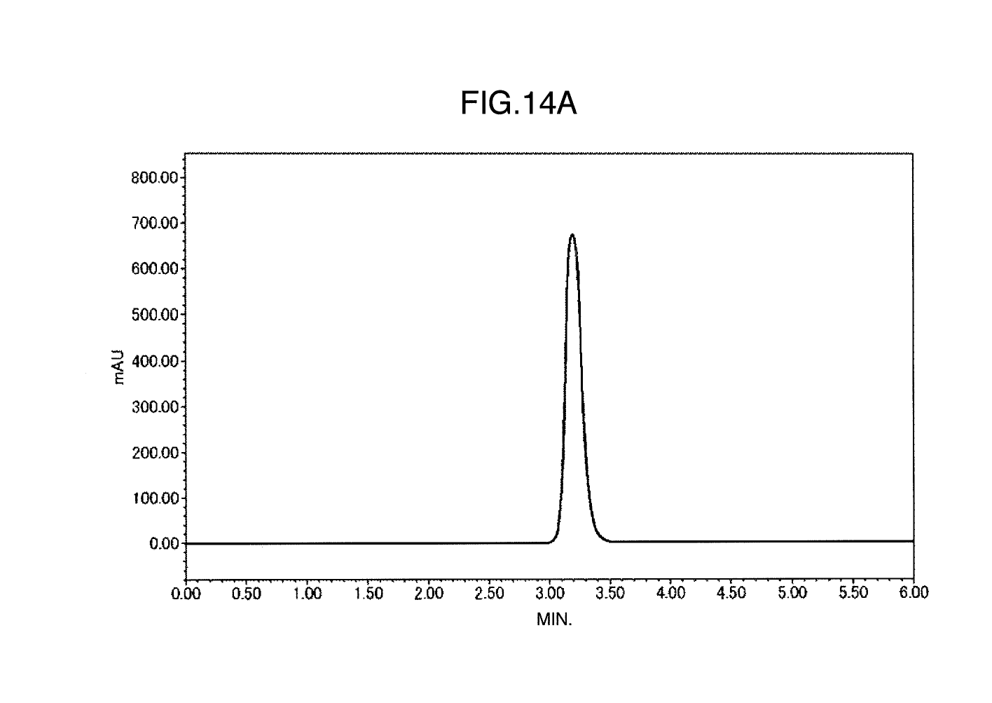

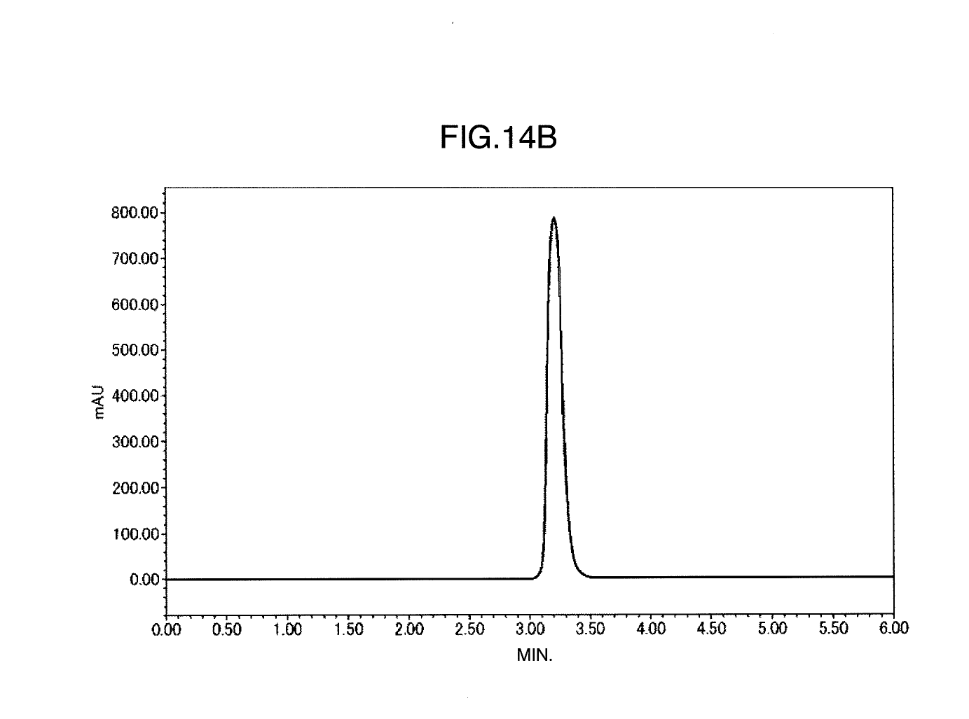

FIGS. 13A, 13B, 14A and 14B are graphs showing examples of chromatograms. FIG. 13A shows a result of a conventional device configuration. FIG. 13B shows a result of the device configuration of the present invention. Analysis conditions are set such that the sample is 60 ppm methylparaben, the sample solution is methanol, the mobile phase is 60% methanol aqueous solution, the cleaning solution A is methanol, the cleaning solution B is 60% methanol aqueous solution, the flow rate of the mobile phase is 1 milliliter/min., the column is ODS, the dimensions are 4.6 mmID×150 mmL, the particle diameter is 5 μm, the column temperature is 40° C., the absorbance detection wavelength is 265 nm, and the injection volume is 10 microliters.

FIG. 13A shows a chromatogram in the case where the process shown in FIG. 3 is not performed. FIG. 13B shows a chromatogram in the case where the process shown in FIG. 3 is performed. In the chromatogram shown in FIG. 13A, a ghost peak, which is caused by difference in absorbance between the mobile phase of 60% methanol aqueous solution and the cleaning solution A of methanol and is due to the cleaning solution A of methanol, is detected, before the peak of methylparaben as the target component. In contrast, in FIG. 13B, the ghost peak is completely eliminated in the chromatogram shown in FIG. 13B, because the content in the tube including the buffer tube 13 and the needle 2 is replaced with the cleaning solution B of 60% methanol aqueous solution in the process shown in FIG. 3.

FIG. 14A shows a result of the conventional device configuration. FIG. 14B shows a result of the device configuration of the present invention. The analysis conditions are set such that the sample is 60 ppm methylparaben, the sample solution is 60% methanol aqueous solution, the mobile phase is 60% methanol aqueous solution, the cleaning solution A is 60% methanol aqueous solution, the cleaning solution B is distilled water, the flow rate of the mobile phase is 1 milliliter/min., the column is ODS, the dimensions are 4.6 mmID×150 mmL, the particle diameter is 5 μm, the column temperature is 40° C., the absorbance detection wavelength is 265 nm, and the injection volume is 10 microliters. FIG. 14A is a chromatogram in the case where the process shown in FIG. 3 is not performed. FIG. 14B shows a chromatogram in the case where the process shown in FIG. 3 is performed. In the chromatogram of FIG. 14A, the sample solution of methylparaben as the target component easily dissolves in the cleaning solution A of 60% methanol aqueous solution. Accordingly, the solution is diluted in the sample introduction process, and reaches the column while having a wide bandwidth in the analysis flow path. As a result, the peak width of methylparaben detected by the detector is increased. The peak height of methylparaben is reduced. In contrast, in the chromatogram of FIG. 14B where the process shown in FIG. 3 is performed, the content in the tube including the buffer tube 13 and the needle 2 is replaced with the cleaning solution B of distilled water. As a result, the peak width of methylparaben is reduced, and the peak height is increased by approximately 17%, thus allowing the sensitivity of the liquid chromatograph to be improved.

As described above, in the loop injection scheme, for introducing the total amount of the sample into the column without waste, in the process of temporarily storing the sample to be introduced into the column in the sample storage loop, not only the actual sample solution but also the cleaning solution is also stored in the sample storage loop at the same time. However, according to the embodiment of the present invention, the amount of storage of the cleaning solution can be reduced. Accordingly, the ghost peak on the chromatogram can be eliminated, the peak width can be prevented from being increased, and the degree of separation of the chromatogram is not degraded or the degree of separation is improved, thereby allowing high sensitivity to be achieved.

As described above, the present invention provides a liquid chromatograph and a sample introduction device for a liquid chromatograph that have a high sensitivity and can prevent analysis time from being increased.

The above description has been made on the embodiment. However, the present invention is not limited thereto. Instead, it is apparent for those skilled in the art that various changes and modifications may be made within the scope of the spirit of the present invention and attached claims.

### REFERENCE SIGNS LIST

1 sample retaining container

2 needle

3 sample inlet

5 sample storage loop

6 column

7 pump

8 injection valve

10 cleaning tank

11 syringe

13 buffer tube

14 sample rack

15 cleaning pump

16 syringe valve

17 plunger cleaning flow path

18 three-way valve

20, 21 cleaning solution container

22, 23 drain

24, 25 deaerator

201 operation controller

202 needle moving mechanism

203 syringe operation mechanism

204 cleaning unit operation mechanism

205 syringe valve operation mechanism

206 three-way valve operation mechanism

207 injection valve operation mechanism

1. A liquid chromatograph comprising,
a first flow passage switching means including a sample storage loop to switch the sample storage loop between a connection thereof to a flow passage of a mobile phase and a disconnection thereof from the flow passage of the mobile phase,
a needle for sucking and discharging a sample,
a metering means for performing sucking of the sample into the needle and discharging the sample while metrizing the sample,
a washing solution feeding means transferring a washing solution,
a second flow passage switching means switching at least two kinds of the washing solution,
a third flow passage switching means performing switching between a connection between the needle and the metering means and a connection between the needle and the washing solution feeding means, and
a control means controlling operations of the first flow passage switching means, the metering means, the washing solution feeding means, the second flow passage switching means and the third flow passage switching means.

2. The liquid chromatograph of claim 1, characterized in that the first flow passage switching means has a sample injection port to be connected to the needle, and the whole of the sample is injected into the sample storage loop while one of the at least two kinds of the washing solution is injected into a flow passage extending from the sample storage loop to the sample injection port.

3. The liquid chromatograph of claim 2, characterized in that the needle is lavaged with another washing solution other than the washing solution injected into the flow passage extending from the sample storage loop of the first flow passage switching means to the sample injection port.

4. The liquid chromatograph of claim 1, characterized in that the needle is lavaged with a washing solution whose components are equal to those of the mobile phase.

5. The liquid chromatograph of claim 1, characterized in that the needle is lavaged with a washing solution whose components are different from those of the mobile phase.

6. A sample introduction device for a liquid chromatograph to be used in a liquid chromatograph for detecting a component separated from a sample injected into a flow passage of a mobile phase, comprising,
a first flow passage switching means including a sample storage loop to switch the sample storage loop between a connection thereof to the flow passage of the mobile phase and a disconnection thereof from the flow passage of the mobile phase,
a needle for sucking and discharging the sample,
a metering means performing sucking of the sample into the needle and discharging the sample while metrizing the sample,
a washing solution feeding means transferring a washing solution,
a second flow passage switching means switching at least two kinds of the washing solution,
a third flow passage switching means performing switching between a connection between the needle and the metering means and a connection between the needle and the washing solution feeding means, and
a control means controlling operations of the first flow passage switching means, the metering means, the washing solution feeding means, the second flow passage switching means and the third flow passage switching means.

7. The sample introduction device for the liquid chromatograph of claim 6, characterized in that the first flow passage switching means has a sample injection port, and performs switching between a connection of the sample storage loop to the flow passage of the mobile phase and a connection of the of the sample storage loop to the sample injection port.

8. The sample introduction device for the liquid chromatograph of claim 6, characterized by further comprising a pump means connected to the sample storage loop to discharge from the sample storage loop the sample stored in the sample storage loop.

9. A washing method of a sample introduction device for a liquid chromatograph to be used in a liquid chromatograph for detecting a component separated from a sample injected into a flow passage of a mobile phase, wherein a washing solution includes a first washing solution and a second washing solution, comprising the steps of,
a step of washing an inside of a needle with the first washing solution supplied to the needle, the needle sucking and discharging the sample,
a step of washing an outside of the needle with immersing the needle into a washing bath,
a step of sucking the sample into the needle while metrizing the sample,
a step of supplying the sample sucked into the needle to a sample storage loop of a first flow passage switching means,
a step of supplying the sample stored in the sample storage loop to the flow passage of the mobile phase, and
a step of washing the inside of the needle with the second washing solution.
